(19) United States
(12) Patent Application Publication
(10) Pub. No.: US 2024/0243808 A1
(43) Pub. Date: Jul. 18, 2024

(54) METHOD FOR PREDICTING THE TRAJECTORY OF A SATELLITE

(71) Applicant: BULL SAS, Les Clayes-sous-Bois (FR)

(72) Inventor: Pierre CALMETTES, Toulouse (FR)

(73) Assignee: BULL SAS, Les Clayes-sous-Bois (FR)

(21) Appl. No.: 18/409,043

(22) Filed: Jan. 10, 2024

(30) Foreign Application Priority Data
Jan. 16, 2023 (EP) 23305054.1

(51) Int. Cl. H04B 7/185

(52) U.S. Cl. CPC H04B 7/18519

(57) ABSTRACT

The invention relates to a method of predicting a trajectory of a given satellite, including training a machine learning algorithm to predict the trajectory of the given satellite from a data set of given satellite, the algorithm being encoded in a programming language; integrating the trained algorithm, on an integrated circuit, by converting the programming language into a hardware description language; and predicting the trajectory of the given satellite given by the integrated algorithm, from a data set of the given satellite. The training and integrating are performed on the ground on a computer comprising at least one processor and the predicting is performed on board the given satellite embarking the integrated circuit.

### TECHNICAL FIELD

The technical field of the invention is the space field and more particularly that of satellite trajectory prediction.

The present invention relates to a method of predicting the trajectory of a satellite and more particularly a method of predicting the trajectory of a satellite performed on board the satellite. The present invention also relates to a method of managing spatial collisions involving a satellite and a satellite configured to predict its own trajectory.

### BACKGROUND

To prevent an artificial satellite from colliding with space debris, a celestial body or another satellite, it is essential to predict its upcoming trajectory in order to be able to predict and prevent these collisions, by deviating the satellite from this trajectory where applicable.

Currently, satellite trajectory estimation is performed by ground stations, either from radar systems or via physics-based prediction models, and trajectory change instructions are sent to the satellite from the ground.

However, such an operation is unsatisfactory in the event that communication from the ground to the satellite is degraded or even impossible. This is because the satellite no longer receives any instructions from the ground and will therefore not deviate from its trajectory in time to avoid the collision.

There is therefore a need for a method that allows an artificial satellite to avoid collisions even when uplink communication is limited or non-existent.

### SUMMARY

The invention provides a solution to the previously mentioned problems, by allowing a satellite to avoid collisions without a ground station having to send it trajectory deviation instructions.

A first aspect of the invention relates to a method of predicting the trajectory of a given satellite, comprising:
a step of training a machine learning algorithm to make it capable of predicting the trajectory of a satellite from a set of data relating to the satellite, the algorithm being encoded in a programming language;
a step of integrating the trained algorithm, on an integrated circuit intended to be embarked on the given satellite, by converting the programming language into a hardware description language;
a step of predicting the trajectory of the given satellite by the integrated algorithm, from a set of data relating to the given satellite;
   the steps of training and integration being performed on the ground on a computer comprising at least one processor and the step of predicting being performed on board the given satellite embarking the integrated circuit.

Thanks to the invention, the trajectory of a satellite is estimated by the satellite itself, embarking an integrated circuit integrating a machine learning algorithm previously trained on the ground to predict the trajectory of a satellite, from a data set of the satellite accessible to the satellite without having to communicate with a ground station.

Thus, the estimation is accurate, uses only little computing power and memory size typically reduced in satellites, and requires little data and hardware, unlike the methods of the prior art that need to calculate the forces exerted on the satellite or a radar antenna to perform the estimation.

In addition to the characteristics that have just been mentioned in the preceding paragraph, the method according to the first aspect of the invention may have one or more additional characteristics among the following, considered individually or according to any technically permissible combination.

According to one embodiment, the algorithm uses a network of artificial neurons.

According to an embodiment of the preceding embodiment, the algorithm uses a long-term and short-term memory network.

Long-term and short-term memory networks are particularly accurate in the prediction of time series.

According to an embodiment compatible with the preceding embodiment, the training is supervised and performed using a training database comprising:
a set of training data sets, each training data set comprising at least one piece of data relating to a training satellite, and
for each training data set, the trajectory of the corresponding training satellite.

According to an embodiment compatible with the preceding embodiments, each data set comprises position and speed data of the satellite at the time of the prediction or at a time prior to the time of the prediction.

According to an embodiment compatible with the preceding embodiments, the programming language is Python or C++.

According to an embodiment compatible with the preceding embodiments, the integrated circuit is an application-specific integrated circuit or a programmable integrated circuit.

According to an embodiment compatible with the preceding embodiments, the hardware description language is VHDL or Verilog.

According to an embodiment compatible with the preceding embodiments, the method according to the first aspect of the invention further comprises a step of sending the trajectory prediction to a ground station.

A second aspect of the invention relates to a method of managing spatial collisions involving a given satellite, comprising the steps of the method according to the first aspect of the invention and:
a step of predicting from the trajectory prediction, of possible upcoming collisions involving the given satellite;
if a collision is expected, a step of calculating from the trajectory prediction, a trajectory deviation instruction for the given satellite.

Thus, the trajectory prediction may be used to anticipate and prevent collisions involving the satellite.

A third aspect of the invention relates to a computer program product comprising instructions which, when the program is executed on a computer, lead the latter to implement the steps of training and integrating of the method according to the first or second aspect of the invention.

A fourth aspect of the invention relates to a satellite on which an integrated circuit is embarked integrating a machine learning algorithm trained to predict the trajectory of the satellite from a data set relating to the satellite.

The invention and its various applications will be better understood by reading the following description and examining the accompanying figures.

### BRIEF DESCRIPTION OF THE DRAWINGS

The figures are provided for the purposes of information and do not limit the invention in any way.

FIG. 1 is a synoptic diagram of a method of predicting according to the invention.

FIG. 2 is a schematic representation of a satellite according to the invention.

FIG. 3 is a synoptic diagram of a management method according to the invention.

### DETAILED DESCRIPTION

Unless otherwise specified, the same item appearing on different figures has a unique reference.

A first aspect of the invention relates to a method of predicting the trajectory of an artificial satellite.

“Trajectory of an artificial satellite” means the curve described by the satellite around Earth or another heavenly body.

FIG. 2 shows a schematic representation of an artificial satellite 200 describing a trajectory 202 around Earth.

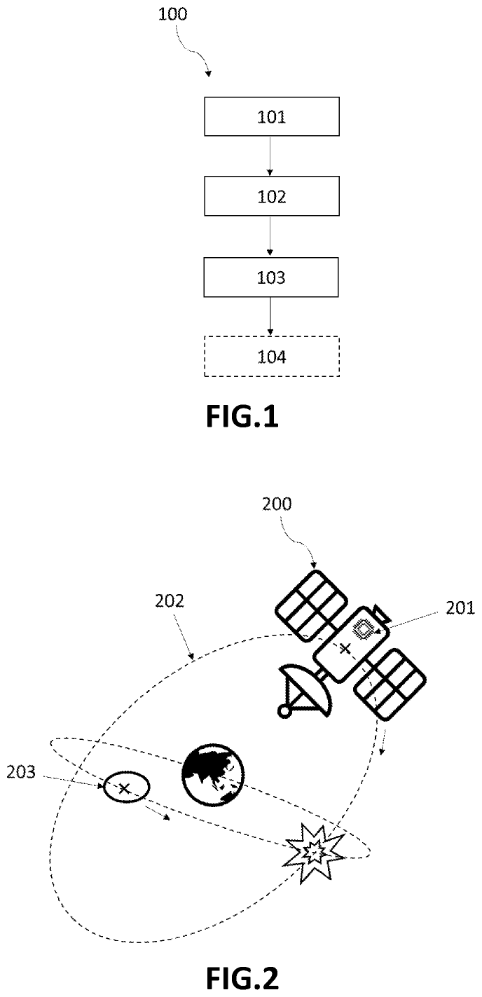

The method 100 of predicting according to the invention comprises several steps, the sequence of which is shown in FIG. 1.

A first step 101 of the method 100 consists in training a machine learning algorithm in order to make it capable of providing as output a prediction of the trajectory 202 of any satellite 200, when it is provided as input with a data set relating to this satellite 200.

The data set relating to the satellite 200 comprises position data and speed data of the satellite 200 at the time of prediction or at a time prior to the time of the prediction.

The prediction of the trajectory 202 comprises position data for a plurality of consecutive times at the time of prediction.

The position data is, for example, the three-dimensional coordinates of the position and the speed data is, for example, the three-dimensional components of the speed of the satellite 200.

Training step 101 consists in updating the machine learning algorithm parameters in such a way as to minimize the difference between the prediction made by the algorithm from the data set provided as input and the prediction it should make from this data set.

The training is performed on a training database comprising a plurality of training data sets. Each training data set comprises at least one piece of data relating to a training satellite 200.

A training data set comprises the same type of data as the data set relating to the satellite 200 described previously.

The training is for example of the supervised type. In this case, the training database further comprises, for each training data set, the trajectory 202 of the training satellite 200 corresponding to the training data set.

The first step 101 then consists in updating the parameters of the machine learning algorithm so as to minimize the difference between the trajectory 202 predicted by the algorithm from each training data set and the trajectory 202 associated with the training data set in the training database.

In practice, the training database may comprise, for at least one training satellite 200, a set of training data sets comprising a plurality of data sets corresponding to position and speed data of the training satellite 200 taken at a regular interval for a defined period of time.

For a given training data set of training data sets, the associated trajectory 202 then corresponds to the position data of the training satellite 200 taken at the times following the moment associated with the given training data set.

For example, such a training database was made publicly available following the IDAO 2020 competition (for “International Data Analytics Olympiad 2020”).

The machine learning algorithm uses for example a network of artificial neurons, and more particularly a long-term and short-term memory network, also known as Long-Short Term Memory LSTM network.

The artificial neuron network is for example capable of providing, from a data set relating to a satellite 200, a prediction of the position and speed of the satellite 200 at a subsequent time.

A prediction of the trajectory 202 of the satellite 200 may then be obtained by providing as input of the artificial neuron network, initially the data set relating to the satellite 200, then the successive predictions provided as output by the artificial neuron network.

The machine learning algorithm is encoded in a programming language, for example Python or C++, and the first step 101 is implemented by a computer comprising at least one processor, which may or may not be graphical, for example of the CPU type (for “Central Processing Unit”) or GPU type (for “Graphical Processing Unit”).

A second step 102 of the method 100 consists in integrating the trained machine learning algorithm, i.e. the algorithm at the end of the first step 101, on an integrated circuit 201.

The integrated circuit 201 may be an application-specific integrated circuit, for example an ASIC board (for “Application-Specific Integrated Circuit”), or a programmable integrated circuit, for example an FPGA (for “Field Programmable Gate Array”).

To perform the integration of the trained machine learning algorithm, the code of the algorithm in programming language is converted into a hardware description language.

The hardware description language is for example the VHDL or Verilog language.

The second step 102 is also implemented by a computer, for example by using software that automatically performs the conversion, such as the Vivado HLS tool.

The integrated circuit 201 integrating the trained machine learning algorithm, i.e. the integrated circuit 201 at the end of the second step 102, is then embarked on the satellite 200 the trajectory 202 of which is to be predicted, as shown in FIG. 2.

A third step 103 of the method 100 consists in predicting the trajectory 202 of the satellite 200.

The prediction is performed by the machine learning algorithm integrated on the integrated circuit 201, and thus on board the satellite 200, from a data set relating to the satellite 200 such as described previously.

The method 100 according to the invention may also comprise an optional fourth step 104 of sending to a ground station, of the prediction of trajectory 202 obtained at the end of the third step 103, in the event that means ensuring the communication of the satellite 200 to Earth are functional.

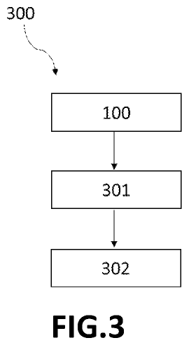

A second aspect of the invention relates to a method 300 of managing spatial collisions involving the artificial satellite 200, comprising several steps the sequence of which is shown in FIG. 3.

The method 300 of managing according to the invention comprises the steps of the method 100 of predicting enabling a trajectory 202 prediction to be obtained for the satellite 200, as well as a first step 301 and a second step 302.

The first step 301 and the second step 302 of the method 300 may be performed on board the satellite, or on the ground if the trajectory 202 prediction for the satellite 200 has been sent to a ground station, i.e. if the fourth step 104 of the method 100 has been performed.

The first step 301 of the method 300 consists in predicting possible upcoming collisions involving the satellite 200.

The prediction is made from the trajectory 202 prediction obtained for the satellite 200.

The prediction may consist in comparing the predicted trajectory 202 for the satellite 200 with the trajectory 202 of each space object 203 located in an area close to the satellite 200.

A space object 203 is, for example, another satellite 200, space debris or a celestial body.

The trajectory 202 of a space object 203 located in an area close to the satellite 200 may be calculated by a ground station and possibly sent to the satellite 200, sent by another satellite 200, or estimated by the satellite 200 from sensor data, such as images or RADAR readings.

A collision with a space object 203 is considered to be predicted if, for a given time, the position of the satellite 200 and the position of the space object 203 is similar or close.

FIG. 2 shows a space object 203 orbiting the Earth that will end up on the trajectory of satellite 200.

The second step 302 of the method 300 is performed if a collision is planned following the first step 301, and consists in calculating a trajectory deviation instruction for the satellite 200.

The calculation is performed from the trajectory 202 prediction obtained for the satellite 200.

1. A method for predicting a trajectory of a given satellite, the method comprising:
training a machine learning algorithm to make it capable of predicting the trajectory of a given satellite from a data set relating to the given satellite, the machine learning algorithm being encoded in a programming language;
integrating the machine learning algorithm that is trained, on an integrated circuit configured to be embarked on the given satellite, by converting the programming language into a hardware description language; and,
predicting the trajectory of the given satellite given by the machine learning algorithm that is integrated, from a data set relating to the given satellite;
wherein said training and said integrating are performed on a ground on a computer comprising at least one processor, and
wherein said predicting is performed on board the given satellite embarking the integrated circuit.

2. The method according to claim 1, wherein the machine learning algorithm uses a network of artificial neurons.

3. The method according to claim 2, wherein the machine learning algorithm uses a long-term and short-term memory network.

4. The method according to claim 1, wherein the training is supervised and performed using a training database, said training database comprising
a set of training data sets, each training data set of said set of training data sets comprising at least one piece of data relating to a training satellite, and
for each training data set, the trajectory of the training satellite corresponding thereto.

5. The method according to claim 1, wherein each data set comprises position and speed data of the given satellite at a time of prediction or at a time prior to the time of the prediction.

6. The method according to claim 1, wherein the programming language is Python or C++.

7. The method according to claim 1, wherein the integrated circuit is an application-specific integrated circuit or programmable integrated circuit.

8. The method according to claim 1, wherein the hardware description language is VHDL or Verilog.

9. The method according to claim 1, further comprising sending the trajectory that is predicted to a ground station.

10. The method according to claim 1, further comprising
predicting from the trajectory that is predicted, possible upcoming collisions involving the given satellite; and,
if a collision is expected, calculating from the trajectory that is predicted, a trajectory deviation instruction for the given satellite.

11. A non-transitory computer program product comprising instructions which, when the non-transitory computer program product is executed on a computer, the computer is configured to implement a method for predicting a trajectory of a given satellite, the method comprising:
training a machine learning algorithm to make it capable of predicting the trajectory of the given satellite from a data set relating to the given satellite, the machine learning algorithm being encoded in a programming language;
integrating the machine learning algorithm that is trained, on an integrated circuit configured to be embarked on the given satellite, by converting the programming language into a hardware description language; and,
predicting the trajectory of the given satellite given by the machine learning algorithm that is integrated, from a data set relating to the given satellite;
wherein said training and said integrating are performed on a ground on a computer comprising at least one processor, and
wherein said predicting is performed on board the given satellite embarking the integrated circuit.

12. A satellite comprising:
an integrated circuit integrating a machine learning algorithm;
wherein the machine learning algorithm is trained to predict a trajectory of the satellite from a data set relating to the satellite, the machine learning algorithm being encoded in a programming language;
wherein the machine learning algorithm that is trained is integrated on the integrated circuit by converting the programming language into a hardware description language; and,
wherein training and integrating of the machine learning algorithm are performed on a ground on a computer comprising at least one processor, and
wherein predicting the trajectory is performed on board the satellite comprising the integrated circuit.
